(19) United States
(12) Patent Application Publication
(10) Pub. No.: US 2010/0053748 A1
(43) Pub. Date: Mar. 4, 2010

(54) REAR PROJECTION FABRIC, REAR PROJECTION SCREEN, AND REAR PROJECTION SYSTEM

(75) Inventors: Noemi Rohner, Rheineck (CH); Thomas Hirt, Rebstein/SG (CH); Yves Clerc, Ebertswil (CH)

Correspondence Address: BACHMAN & LAPOINTE, P.C., 900 CHAPEL STREET, SUITE 1201, NEW HAVEN, CT, 06510, US

(73) Assignee: SEFAR AG, Thal/SC (CH)

(21) Appl. No.: 12/444,868

(22) PCT Filed: Oct. 11, 2007
(86) PCT No.: PCT/EP2007/008835

§ 371 Date: Sep. 2, 2009

(30) Foreign Application Priority Data
Oct. 11, 2006 (DE) 10 2006 048 473.8

(51) Int. Cl. G03B 21/56; D03D 1/00

(52) U.S. Cl. 359/460; 428/68; 442/60

(57) ABSTRACT

Thin high-density fabrics are particularly suitable for super wide-angle rear projections that are accurate in every detail. Based on said recognition, the invention relates to a rear projection fabric (20, 30) that comprises a number of threads (21, 23, 31, 33) and has a density of more than seven threads per millimeter, the maximum diameter of a thread being less than 0.06 mm. The invention further relates to a rear projection screen (10) which comprises such a rear projection fabric (20, 30) and can create a wide-angle rear projection image (41) that is particularly accurate in every detail. More particularly, such a rear projection screen (10) makes it possible to create a relatively inexpensive rear projection system (40) which can be designed by means of the standard power of a projector (43), e.g. in the form of a beamer or laser.

The invention relates to a rear projection fabric, a rear projection screen, a rear projection system and an application.

A rear projection screen has a rear projection surface onto which a positive image can be projected from the rear. Accordingly, projectors and rear projection screens are intended to be capable of illuminating a large surface area in a uniform manner and, to this end, rear projection surfaces should comply with specific parameters. On the one hand, they should provide a sharp, high-resolution image which is illuminated in a uniform manner as far as the edges, but not form any hotspots. The term hotspot is used to refer to the projector light source, which is generally applied as a point light source at a comparatively large distance, shining through the rear projection surface.

Special screens were thus already required for cinematographic applications from a very early time for rear projection, comparatively thick screens by current standards, for example, of the type described in GB188111A. Before this time, they were also produced from acetyl cellulose, as described, for example, in GB401700A. To this end, the fluid was sprayed onto large glass plates and removed after drying. Later, screens were also produced from nylon, perlon or glass fibre, as described, for example, in GB494003A.

Also for cinematographic applications, GB511578A discloses an optical rear projection surface in which the projection surface material comprises a loosely woven fabric with swollen threads so that the intermediate spaces are substantially closed. The fabric is impregnated with a transparent or light-permeable non-volatile substance. Also known from this time are fluorescent additives, such as those in U.S. Pat. No. 5,045,706A, in order to increase the brightness, or other additives such as those in GB427062A or GB401700A, in order to improve or vary translucent or transparent properties or in order to improve reflective properties as in GB494003A.

GB 540,009 discloses a front projection screen from the time of silent films, which has strips or webs which are interwoven in order to reinforce a base fabric and which has interwoven openings which are effectively acoustically permeable in order to allow the transmission of sound. The multifilament front projection fabric is not suitable for showing images which are projected from the rear since this is prevented by the sound openings and the wide reinforcement strips.

Such outdated, comparatively thick rear projection screens—generally formed with linen fabric or swelling threads—for cinematographic applications require the use of very powerful projection lamps of up to 5 000 Watt incandescent light or carbon arc lamps of up to 10 000 Watt. For example, therefore, normal cinema projectors are of only limited use for rear projection with these screens since they do not have the required perfect picture steadiness and the triple rotating shutter which, in the cinema, reduces the flickering effect and reduces light intensity.

Modern projectors, such as lasers and data projectors open up new possibilities and new requirements. Consequently, modern rear projection screens are intended to constitute a compromise between the diffusion and the permeability of the screen. As the rear projection surface of the rear projection screen becomes brighter, that is to say, as the permeability increases, the decrease of light at the edges becomes greater. Therefore, the rear projection fabrics mentioned above are often too thick for use in modern rear projection systems.

JP2005189583AA discloses a woven or knitted fabric, in combination with an LCD light source, which is only suitable as an optical diffuser. This is an application for a surface light source with a very small distance between the surface light source and diffuser.

JP06175228A also discloses, for suppressing scattered light and fitting to a video screen, a reflective screen which is produced with comparatively thin threads, with perforated apertures being formed in the range from 0.8 to 2.0 mm.

Only one other reflective screen for reducing health risks when viewing a cathode ray tube directly from the front is disclosed in U.S. Pat. No. 4,864,190, using comparatively thin black metal filaments. The reflective screen therefore has no textile fabric. The reflective screen is configured for light absorption and for being fitted directly to a surface light source.

These and similar reflective screens are preferably constructed so as to be dark so that they can be used, in the same manner as the fabrics described above in JP06175228A and JP2005189583AA, as absorbent filters for the prevention of scatter effects and for being fitted directly to a flat transmitter such as television and/or video screens. Use over a large surface area in combination with a point light source is already sufficient to prevent them from being suitable for use as rear projection fabrics.

The basic principle with rear projection screens, with modern light sources, in particular point light sources, such as, for example, data projectors, lasers, LEDs or LCDs is as follows.

The rear projection screen scatters the light beams which are directed so as to be incident with respect to each image point of the rear side by means of scattering on the surface or by means of multiple scattering inside on a layer of the material. It is thereby possible, at the side of the viewer, for the image point to be transmitted in a diffused manner as an open beam cluster from the image surface. Since the light scattering at the surface or within the rear projection wall material leads not only to the light being directed further in a forward direction but also, to a degree, to back scattering of the light from the rear projection surface, this light transmission is always impaired by losses. An overview of this problem with regard to modern projectors and projection techniques can be found in DE19703592A1. However, a holographic screen which is disclosed therein is found to be comparatively inflexible to handle and also comparatively costly in terms of production and marketing.

It has also been established that the problems described above, precisely with respect to modern rear projection techniques and applications with point light sources at a comparatively large distance from the rear projection surface—in particular in everyday use outside cinema studios—not only with respect to ease of handling, but also with respect to image quality and image resolution, brightness, contrast and viewing field or viewing angle range—are more serious than ever and require a special configuration of the rear projection surface with respect to the rear projection and where applicable other application-specific parameters.

US 2006/0187544 A1 discloses a projection wall, attempts being made to make said wall suitable for simultaneous front and rear projection, by providing it, in the non-illuminated state, with a comparatively high degree of transparency, that is to say, open-looping. To this end, the front and rear projection wall according to the definition of US 2006/0187544 A1 has a synthetic, multifilament and knitted surface structure which has a comparatively high opening density. To this end, therefore, at least two opaque fibres are interwoven to form thread thicknesses of 0.3 mm, the threads having spacings of 1.2 mm so as each to define a mesh opening with a dimension which is at least approximately 0.65 mm or above. Allegedly, this is intended to achieve a uniform brightness over a viewing angle of up to 180°. However, this last objective cannot be achieved or can be achieved only in a very unsatisfactory manner with the comparatively thick fabric, owing to the high degree of transparency—in any case, the image quality or image resolution is impaired.

It is desirable to have a fabric which is constructed specifically for rear projection and which is significantly improved in terms of its properties.

This is the basis of the invention, the object of which is to provide a rear projection fabric, a rear projection screen, a rear projection system and an application, in which a viewing angle range of up to 180° can be achieved or in which a viewing angle range compared with the prior art, in particular with regard to rear projection, is in any case improved. In particular, comparatively high-quality image reproduction is further intended to be ensured, that is to say, for example, brightness and/or contrast and/or diffuser properties of the projection fabric with an image reproduction quality or image resolution which is nonetheless detailed, in particular with regard to rear projection, are also intended to be improved.

With regard to the rear projection fabric, the object is achieved by the invention with a rear projection fabric for a rear projection screen which is woven from a number of threads having a thread density greater than seven (7) threads per millimetre, the maximum diameter of a thread being less than 0.06 millimetres (60 micrometres).

A rear projection fabric is intended to refer to a fabric which is provided and constructed exclusively for rear projection. A fibre is intended to refer to the portion of a thread, synonymous with a yarn. The fabric is produced from a plurality of threads. In this respect, a thread is to be understood as a collective term for all linear textile structures. Accordingly, a thread is correspondingly a long thin structure comprising one or more fibres. A fabric is a generally rectangular surface structure comprising threads. The threads in the longitudinal direction are referred to as the warp or warp threads. The transverse threads are referred to as the weft or weft threads. Fabrics are consequently understood to be textile surface structures comprising at least two interwoven thread systems which preferably meet at right-angles. The thread density or thread count gives the number of threads per millimetre, a thread count tolerance giving the generally admissible deviation of the arithmetic mean values with respect to the nominal value. The thread count tolerance is intended in this instance to be below 2 threads per millimetre, preferably below 1 thread per millimetre, preferably approximately 5 threads per centimetre or less. The thread or yarn diameter can in this instance be understood as a diameter in the interwoven or non-interwoven state of the yarn—preferably it is intended to be understood as a diameter in the non-interwoven state of the yarn.

The invention is based on the consideration that a rear projection fabric must be produced in a more open manner the thicker it is constructed in order to allow adequate brightness and contrast ratios. The thicker a fabric is, the smaller the viewing angle range is for the rear-projected screen—in an extreme case, the rear-projected image is scattered forwards only in a narrow angular range of a few degrees about the vertical, that is to say, about the projection direction. An excessive degree of open-looping of the fabric, as in US 2006/0187544 A1, can partially compensate for this but at the same time reduces the precision of the detail or resolution of the projected image. Consequently, two significant aspects of the reproduction quality of an image are reduced in a disadvantageous manner.

Based on this consideration, the invention has first recognised that a rear projection structure can, surprisingly, advantageously be configured in the form of a fabric. This results in substantially more uniform scattering and diffusion properties which ultimately, compared with knitted textiles, enable improved image quality during rear projection.

Furthermore, the concept of the invention makes provision for the rear projection fabric to be able to be produced with particularly thin threads and with a particularly high thread density. According to the invention, the fabric is woven with a thread density greater than 7 threads per millimetre, the maximum diameter of a thread being less than 60 μm.

Owing to the high thread density according to the invention, with threads which are comparatively thin at the same time, a particularly high level of detail precision is achieved in the image reproduction, other image reproduction parameters, such as brightness and contrast and permeability of the fabric, also being ensured with sufficiently high quality. Compared with the prior art, the rear projection fabric has a significantly higher number of scatter centres—and consequently image points—which, owing to the fabric form, further allow comparatively uniform image reproduction. Owing to the comparatively thin threads which are provided, it is possible for a light beam which strikes the rear side of the fabric to be scattered forwards in a substantially increased angular range, practically up to an angular range of 180°. This allows a significantly increased viewing angle range compared with the prior art.

In the claimed combination according to the concept of the invention, it is therefore possible to achieve a particularly precisely detailed image reproduction and it is nonetheless possible to achieve a viewing angle range of up to 180° during rear projection. It has been found that the detail precision increases as the thread density increases, whilst thread densities of less than 7 threads per millimetre often lead to comparatively unsuitable results and in particular result in excessive light-permeability and a hotspot problem, in particular with preferred high light intensities. Furthermore, it has been found that a viewing angle range of up to 180° can be achieved in a particularly effective manner with comparatively thin threads having a diameter of less than 60 μm, whilst thicker threads regularly lead to a limitation of the viewing angle range.

In addition, a diffuser layer leads to increased homogeneity of the rear-projected image and prevents optical artefacts. At the same time, the diffuser layer synergetically serves to improve the mechanical property of the rear projection fabric, in particular with respect to elasticity and relaxation consistency.

The invention also relates to a rear projection screen having a rear projection surface which is formed by a rear projection fabric according to the concept of the invention or a development thereof. Preferably, the rear projection screen has a sleeve which surrounds the rear projection surface and securing means.

The invention also relates to a rear projection system having a rear projection screen according to the concept of the invention or a development thereof and a projector for projecting an image onto the rear side of the rear projection screen.

The invention also relates to the use of a rear projection fabric during a rear projection of stationary or moving images.

Advantageous embodiments of the invention will be appreciated from the dependent claims and set out in detail advantageous possibilities for implementing the concept explained above in the context of the problem addressed and with respect to additional advantages.

In principle, the rear projection fabric can be produced with extremely different forms of threads. A rear projection fabric has been found to be particularly preferred in which a thread is produced in the form of a monofilament thread. The detailed precision of the image has been found to be particularly good. In addition to the good optical properties which have been explained, monofilament fabrics with thread densities and thread diameters in accordance with the concept of the invention, are characterised by a surprisingly high modulus of elasticity, which is important for the tension characteristics, relaxation values of such a monofilament fabric being advantageously low. This results in the particular advantage that the monofilament fabric remains more inherently stable than other fabrics. Furthermore, in an only slightly tensioned state, a comparatively smooth surface is already achieved, that is to say, practically without any undulation formation, and even after prolonged use in the tensioned state, at the most a practically negligible relaxation of the monofilament fabric is evident. These mechanical properties of a monofilament fabric, which are important for the practical use of a rear projection fabric—in particular for presentation surfaces in conference rooms or the like with long holding times—make it particularly suitable. Owing to the high modulus of elasticity of the monofilament fabric, it has been found to be particularly flexible. Finally, a monofilament fabric also has a weight advantage with respect to other fabric types. Regardless of a diffuser layer, advantageous weights in the order of from 10 to 100 g/m² are achieved.

In an alternative development, a thread may be produced in the form of a multifilament thread, comprising at least two fibres. This development has also been found to be optically and mechanically particularly advantageous, although less superior than a monofilament fabric. For example, however, image reproduction is particularly homogeneous in comparison with a monofilament fabric.

In principle, according to the concept of the invention, a rear projection fabric has been found to be advantageous which is produced with an increasing number of threads per millimetre in order to improve the detail precision of the image. However, the thread density should not exceed a specific value which may also be dependent on a maximum diameter of a thread in order to ensure that the rear projection fabric is sufficiently transparent. Thread densities of up to 20 threads per millimetre can readily be produced.

According to a development of the invention, a rear projection fabric has been found to be particularly advantageous in which the thread density is greater than twelve threads per millimetre, preferably the thread density is less than 35 threads per millimetre, preferably less than 25 threads per millimetre. A rear projection fabric in which the thread density is between 15 and 20 threads per millimetre, advantageously approximately 18 threads per millimetre, has been found comparatively to have particularly advantageous properties.

Furthermore, a preferred development of the invention provides for a thread diameter of less than 0.05 mm, preferably a thread diameter of greater than 0.01 mm. A thread diameter in the range between 0.02 mm and 0.04 mm, advantageously approximately 0.03 mm has been found to be particularly advantageous.

The concept of the present invention which, as explained above, is based on a high thread density with at the same time comparatively thin threads, can be understood particularly well as a “figure of merit” by means of the ratio of thread density to thread diameter. According to a further development of the invention, the ratio of thread density to thread diameter is in the range between 116 1/mm² and 3500 1/mm², preferably in the range between 200 1/mm² and 2000 1/mm², preferably in the range between 400 1/mm² and 1500 1/mm², preferably in the range between 500 1/mm² and 900 1/mm², preferably between 550 1/mm² and 850 1/mm².

Further parameters of the rear projection fabric which can be determined, for example, with an electronic image analysis system are the mesh size and the open area of the rear projection fabric. The mesh size is in principle to be understood to be the spacing between two adjacent warp or weft threads. According to a particularly preferred development of the invention, the rear projection fabric has a mesh size of less than 0.15 mm, preferably less than 0.1 mm, preferably in the range from 0.05 mm to 0.07 mm, preferably approximately 0.055 mm.

The open area (generally designated α₀) is intended to refer to the percentage proportion of all open areas over the entire filtering surface of the fabric. It is generally calculated from the mean values of the mesh size and the effective thread width, that is to say, the maximum diameter of a thread in the interwoven state (in exceptional cases, if necessary, the maximum diameter of a thread in the non-interwoven state). A corresponding calculation formula can be set out as follows:

Open area

$${a}_{0} [ \% ] = \frac{{w}^{2} \cdot 100}{{( w + d )}^{2}} ,$$

the effective thread width being given by

$$d [ µm ] = \frac{10000}{n} - w ,$$

and w being the mesh size and n the thread count in 1/cm.

According to a preferred development, an open area of between 5% and 40% has been found to be particularly advantageous, preferably an open area of between 7% and 25%, preferably an open area of between 9% and 20%. This may be partially dependent on the material of the fibres, for example, a polyester or polyamide fibre. Exemplary values include an open area of 35% with twelve threads per millimetre and a thread diameter of 31 μm or an open area of 19.5% with 18 threads per millimetre and a thread diameter of 30 μm or an open area of 10% with 20 threads per millimetre and a thread diameter of 30 μm. These last values also set out particularly preferred developments of a fabric.

A rear projection fabric with a ratio of thread density to thread diameter of 600 1/mm² (preferably 18 threads per millimetre with a thread diameter of approximately 30 μm) or 733 1/mm² (preferably 22 threads per millimetre with a thread diameter of approximately 30 μm) or 814 1/mm² (preferably 22 threads per millimetre with a thread diameter of approximately 27 μm) has also been found to be particularly advantageous.

In a preferred manner, a thread is formed from one or more opaque fibres or transparent fibres or light-permeable fibres. The last property ensures to a large extent the brightness of the rear projection fabric.

In principle, a thread of the rear projection fabric can be formed from a large number of suitable threads. It has been found to be particularly advantageous for a thread to be formed from one or more synthetic fibres. Synthetic or natural polymer fibres or fibre mixtures therewith have been found to be particularly advantageous.

For example, a thread with a polycondensation fibre is suitable, in particular with a fibre of a material selected from the group comprising:

polyester (PES), polyethylene terephthalate (PET), polyamide (PA), aramid or combinations thereof.

Furthermore, a thread with a polymerisation fibre, in particular with a fibre of a material selected from the group comprising:

polyacrylonitrile (PAN), polytetrafluoroethylene, polyethylene (PE), polypropylene (PP), polyvinyl chloride or combinations thereof, has further been found to be advantageous.

Furthermore, a fibre with a polyaddition fibre, in particular with a fibre of polyurethane (EL) has further been found to be particularly advantageous.

In order to improve the scatter properties of a rear projection fabric with regard to the homogeneity thereof, a diffuser layer is provided in accordance with the concept of the invention. This may impregnate the fabric and/or be applied thereto. In particular a diffuser layer serves to fill and/or cover mesh openings of the fabric. An opaque coating and/or impregnation, in particular an opaque coating and/or impregnation of plastics material on and/or in the rear projection fabric has been found to be particularly advantageous. An impregnation of the fabric can be achieved, for example, by filling the mesh openings with an emulsion or the like. In the same manner, a fabric can additionally or alternatively be coated with a corresponding emulsion.

Advantageously, the fabric is impregnated with diffuser material so that an inner bond of the fabric and the diffuser material is produced. For example, this can be achieved by means of appropriate application of the emulsion to the fabric, the fabric advantageously being completed wetted and/or soaked by the emulsion. As a result, a very thin surface structure is obtained which is impregnated by the emulsion and which is opaque after hardening, that is to say, partially transparent, and in which the carrier properties and optical properties of the fabric and the optical properties of the diffuser layer co-operate with each other in a synergetic manner.

In a particularly preferred development of the invention, it is provided, in order to form a monofilament thread, for an opaque, transparent or partially transparent fibre to be used, in particular a textile fibre. This increases the brightness of the rear projection fabric and the scatter properties thereof inter alia owing to the lens effect when a light beam passes through a thread of the fabric. In this particularly preferred development, particularly thin threads are produced with thicknesses which are less than 50 μm and greater than 25 μm. The thread density in this particularly preferred development is in the range of more than 12 threads per millimetre and less than 20 threads per millimetre. In this particularly preferred development, an opaque coating and/or impregnation of the fabric is provided in order to achieve a diffuser effect for the fabric.

According to the concept of the invention, the rear projection fabric has a diffuser layer. This has the advantage that the homogeneity of the image reproduced during the rear projection is clearly improved. In particular, a so-called rainbow effect or other artefacts caused by light diffraction or light refraction, such as, for example, spectral shifts which are significant for the rainbow effect or spectrally different light refractions, are prevented. Furthermore, the application of a diffuser layer, whether it be as a layer which permeates through the fabric and/or as a layer which is applied to the fabric—as recognised by the invention—leads to a synergistic effect which, in addition to the improvement of the optical image quality, also results in an improvement of the rear projection fabric with respect to its mechanical properties. In particular, this relates to a diffuser layer which is adapted with respect to the modulus of elasticity and/or a relaxation value of the fabric. On the whole, owing to the diffuser layer according to the concept of the invention, homogeneous image reproduction which is resolved well in a manner free from spectral artefacts in the viewing angle range of up to 180° is achieved, the mechanical properties of the rear projection fabric, even under long-term tensioning, being configured similarly so as to be sufficiently flexible and nonetheless limited in an effective manner in terms of their relaxation. This applies in particular to a monofilament rear projection fabric having a thread density and a thread diameter according to the concept of the invention and a diffuser layer.

Preferably the diffuser layer is formed as an opaque impregnation and/or coating. For example, an impregnation of the rear projection fabric can advantageously be achieved via an application of an emulsion—depending on requirements, the emulsion can be applied in the mesh openings and/or coated on the fabric. As explained, the diffuser layer can be adapted, in particular in terms of an modulus of elasticity and/or a relaxation value of the fabric, or advantageously improve an modulus of elasticity and/or a relaxation value of the fabric. A rear projection fabric which is constructed in this manner is found to be sufficiently flexible to be tensioned in a suitable frame or other sleeve or the like with a rear projection screen and, on the other hand, the relaxation of such a rear projection fabric, even in the event of relatively long-term tensioning, such as, for example, with projection surfaces in conference rooms or the like, is sufficiently inherently stable or smooth, without the possibility of undulations impairing the image reproduction.

It has been found to be particularly advantageous for a diffuser layer, in particular an impregnation and/or coating, to be applied as an emulsion. Advantageously, an emulsion is produced in an aqueous manner with polyvinyl alcohol. Polyvinyl alcohol has been found to be a particularly preferred water-soluble emulsifier.

Advantageously, the diffuser layer, in particular in the form of an impregnation and/or coating, can be produced by means of an emulsion which has a wetting agent and/or a preservative. The wetting agent advantageously increases the adhesive bonding with the fabric formed by the threads—this has been found to be particularly advantageous with monofilament fabrics. The preservative advantageously serves to prevent occurrences of fungal growth or bacterial infection, etcetera.

In a particularly preferred development, in order to form the diffuser layer, in particular an impregnation and/or coating, there is provision for the emulsion to have a softening agent and/or elastane. Elasticity agents of this and other types can be selected depending on requirements in order, as explained, to adapt the mechanical properties of the diffuser layer to the mechanical properties of the fabric formed by the threads—this applies in particular to an modulus of elasticity and the relaxation value of the fabric.

In another preferred development of the invention, it has been found to be advantageous for the diffuser layer, in particular an impregnation and/or coating, to be produced with an emulsion which preferably has starch and/or a foaming agent. Opacity agents of this and other types have been found to be particularly preferred for forming the diffuser property of the diffuser layer and have partially light-permeable properties and light-diffusing scattering properties. For example, starch can reinforce or improve the opacity of the diffuser layer. Furthermore, a sufficient quantity of stabilised foam can reinforce or improve the opacity of the diffuser layer. Suitable foaming agents include, for example, soap or the like. Preferably, the emulsion also has an end foaming agent in order to form a diffuser layer as uniformly as possible and to stabilise the foam after application of the emulsion.

Preferably, the diffuser layer, in particular an impregnation and/or coating on the fabric, has an additive which increases the water-resistance of the diffuser layer and which is preferably provided in the emulsion.

Preferably, the additive may be formed as a homo- or copolymer dispersion. An additive based on acetate and/or ethylene and/or acrylester and/or acrylate ester and/or acrylic acid ester has been found to be advantageous. A reinforcement of the water-resistance can preferably also additionally or alternatively be achieved by means of an aldehyde or melamine or urea resin.

Preferably, in order to form the diffuser layer, an emulsion has a hardening agent, in particular an acid and/or an isocyanate.

Advantageously, the emulsion, depending on requirements, may also have a light-amplifying additive, for example, a luminescent and/or phosphorescent additive. In particular, a colour neutrality may be maintained or, if desired, a deviation from the colour neutrality may be consciously accepted.

In the context of a particularly preferred development of the invention, the rear projection fabric according to the concept of the invention has a diffuser layer which is applied by means of an emulsion which is formed with water and a water-soluble emulsifier and which has an opacity agent and an elasticity agent in order to adapt to an modulus of elasticity and/or a relaxation value of the fabric. Preferably, the emulsion further has an agent which increases the water-resistance, a hardening agent and a wetting agent. A rear projection fabric which is formed in this manner has been found to be particularly preferred since synergistically optimised optical properties for a rear-projecting image reproduction and mechanical properties are coordinated with each other.

Embodiments of the invention will now be described below with reference to the drawings. These drawings are not necessarily intended to illustrate the embodiments to scale but instead the drawings, which are intended by way of explanation, are provided in a schematic and/or slightly distorted form. With regard to additions to the teachings which are derived directly from the drawings, reference is made to the relevant prior art. It should be taken into account that a number of modifications and changes relating to the form and detail of an embodiment can be implemented, without deviating from the general concept of the invention. The features of the invention disclosed in the description, in the drawings and in the claims may be significant both individually and in any combination for the development of the invention. In addition, the scope of the invention also includes all combinations of at least two of the features disclosed in the description, the drawings and/or the claims. The general concept of the invention is not limited to the precise form or the detail of the preferred embodiment illustrated and described below or limited to a subject-matter which would be limited in comparison with the subject-matter claimed in the claims. Where dimension ranges are set out, values which lie within the cited limits are also intended to be disclosed as limit values and can be used and claimed as desired.

For further understanding of the invention, preferred embodiments of a rear projection fabric, a rear projection screen and a rear projection system and an application thereof are described with reference to the Figures of the drawings, in which, in detail:

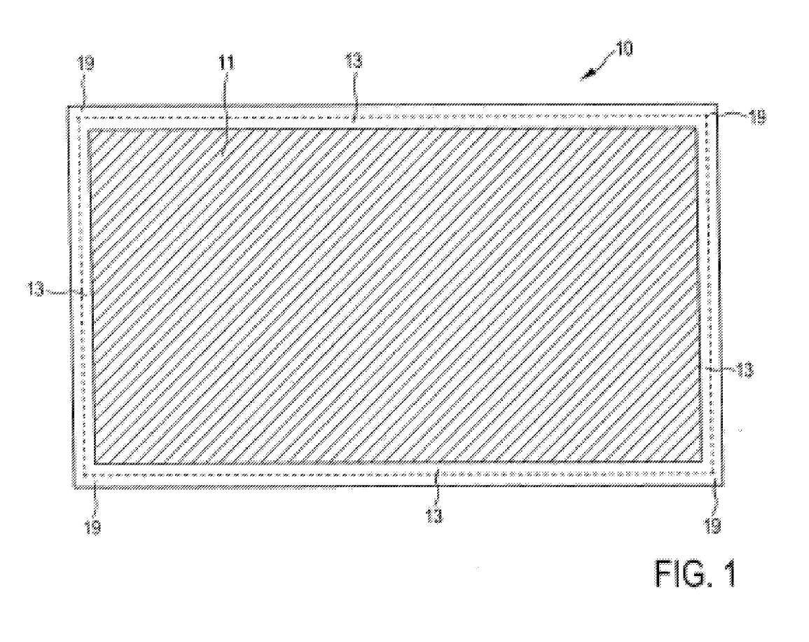

FIG. 1 shows a rear projection screen according to a particularly preferred embodiment of the invention;

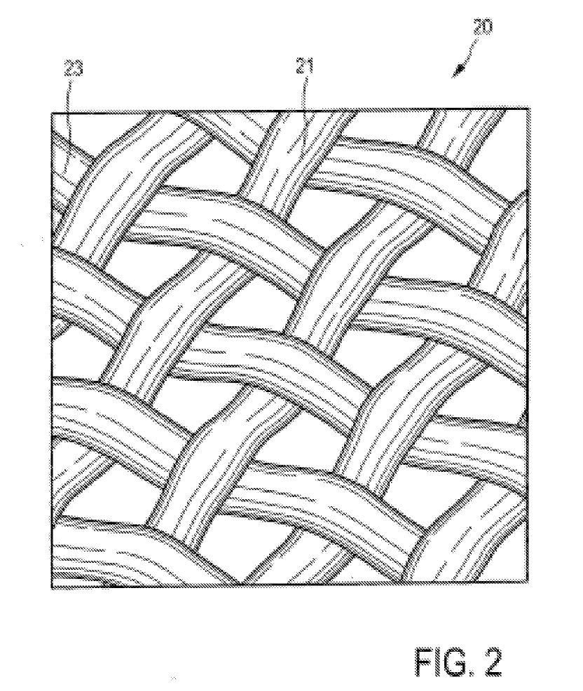

FIG. 2 shows a monofilament rear projection fabric according to a particularly preferred embodiment of the invention for a rear projection surface of a rear projection screen;

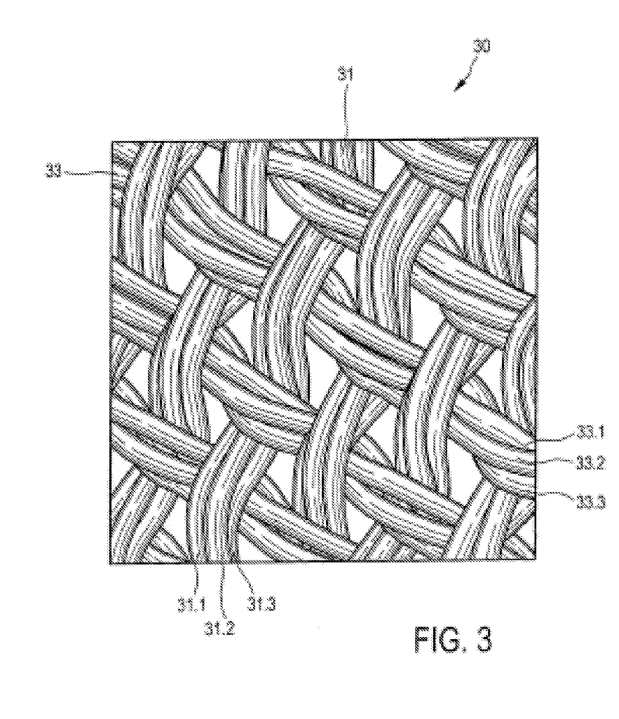

FIG. 3 shows a multifilament rear projection fabric according to another particularly preferred embodiment of the invention for a rear projection surface of a rear projection screen;

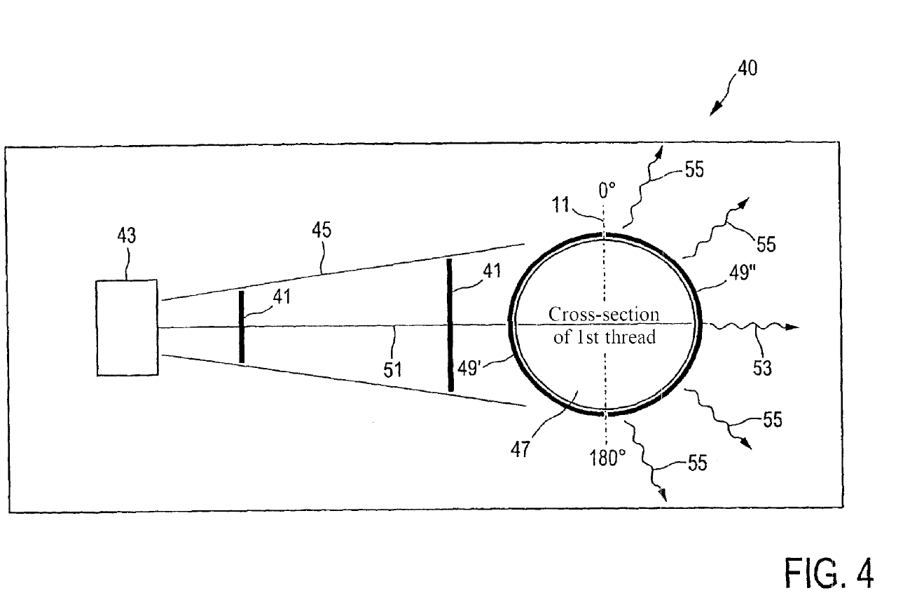

FIG. 4 shows a rear projection system having a projector and schematically indicated rear projection fabric of a rear projection surface of a rear projection screen.

FIG. 1 is a particularly preferred embodiment of a rear projection screen 10. This is formed by a rear projection surface 11 and a sleeve 13 which is secured thereto and surrounds it on all sides. In addition, a tenter which is fitted to the sleeve 13 acts as a securing means 19 in order to allow the rear projection screen 10 to be fitted, for example, to a rod, for example, using straps or the like, which rod is not illustrated in greater detail in this instance. In this embodiment, the sleeve is additionally adhesively bonded to the rear side of the tenter. Other embodiments can also provide for fabrics which have no sleeve and which are, for example, retained only by tensioning rails. The rear projection screen 10 in this instance is rectangular with a rear projection surface 11 which is also rectangular. Other embodiments may further have any other shape of rear projection surface, in particular any polygonal shape.

The rear projection screen 10, in a manner explained in greater detail in FIG. 4, acts as part of a rear projection system 40 for receiving a positive image 41 which is projected from the rear onto the rear projection surface. This image is produced by a projector 43, which is also indicated in FIG. 4, in this instance in the form of a data projector, as a correspondingly high-intensity beam cluster 45 and is shown on the rear side of the rear projection surface 11.

FIG. 2 illustrates a highly enlarged portion of a rear projection fabric 20 according to a first particularly preferred embodiment of the invention, which portion can be reproduced with an electronic image analysis system. The rear projection fabric 20 illustrated in FIG. 2 is formed as can be seen from monofilament threads—vertical warp threads 21 and horizontal weft threads 23 which are guided through the warp threads. In principle, a great variety of fabric types can be used here. In this instance, it is a fabric 20 with a substantially identical upper and lower side and identically formed warp threads 21 and weft threads 23. In this instance, the threads 21, 23 of the fabric 20 are produced as polyamide fibres. In the particularly preferred embodiment of the fabric 20 illustrated in FIG. 2, the monofilament thread 21, 23 has a flattened—substantially elliptical or lenticular—cross-section, the maximum diameter of which is 27 μm. The thread density of the fabric 20 which is illustrated in FIG. 2 is twenty threads 21 per millimetre in the “horizontal” direction or twenty threads 23 per millimetre in the “vertical” direction. Consequently, FIG. 2 illustrates one of the finest monofilament fabrics 20 which, according to the concept of the invention, allows both a previously unknown level of detail precision in terms of image reproduction and a viewing angle range of up to 180°. The first of these is produced primarily by the high thread density, the latter primarily by the small thread diameter. The threads are further constructed so as to be opaque which further promotes the advantageous effect of the fabric explained with respect to homogenised image reproduction. A diffuser layer which is not illustrated in greater detail improves the artefact-free, homogeneous image reproduction. This is explained again in detail with reference to FIG. 4.

In the fabric 20 illustrated in FIG. 2, a diffuser layer which is not illustrated in greater detail and which is of opaque plastics material is applied to a viewing side opposite the rear side in order to conceal mesh openings. Although in the region described, these are practically not visible to the human eye, with illumination from the rear, occurrences of glare could be perceived from a very close front view. A diffuser layer consequently reduces the “graininess” of a rear-projected image, without diminishing the precision of the detail.

FIG. 3 illustrates a greatly enlarged portion of a second particularly preferred embodiment of a rear projection fabric 30 which, in the same manner as in FIG. 2, is again produced with warp threads 31 and weft threads 33, which portion can be reproduced with an electronic image analysis system. A thread 31, 33 is produced in this instance as a multifilament thread 31, 33 with in this case three fibres of polyester which are accordingly designated as 31.1, 31.2 and 31.3 and as 33.1, 33.2 and 33.3, respectively. It has been found that, in spite of the multifilament construction of a thread 31, 33, a thread diameter of approximately 40 μm can nonetheless be achieved with the rear projection fabric 30. The individual fibre 31.1, 31.2, 31.3 and 33.1, 33.2, 33.3, respectively, in this instance has a diameter in the order of 10 μm. The thread density with the rear projection fabric 30 of FIG. 3 is eighteen threads per millimetre. The fabric 30 illustrated in FIG. 3 is consequently undoubtedly one of the finest multifilament fabrics. In comparison with the fabric 20 illustrated in FIG. 2—owing to the multifilament construction of the threads 31, 33—it is found to be less precise in terms of its scatter properties which does, however, have the advantage that, with its comparatively dense construction, in the fabric 30 illustrated in FIG. 3, a comparatively homogeneous image reproduction is already enabled. A diffuser layer is not illustrated in greater detail but can, in the same manner as the diffuser layer in FIG. 2, be produced in different manners set out below with reference to three examples.

### EXAMPLE 1

A diffuser layer is produced as a water-soluble layer which can also be cleaned in an aqueous manner in the fluid state, but which dries to be water-resistant.

A corresponding emulsion contains:
water as a solvent
polyvinyl alcohol as an emulsifier for additives
anti-foaming agents in order to prevent formation of foam
wetting agents in order to improve the adhesive bonding on and/or to the fabric
preservatives in order to prevent occurrences of fungal growth or bacterial infection
starch for the opaque adjustment of the coating, in particular for preventing excessive light refraction and rainbow effects
co-polymer dispersion based on vinyl acetate/ethylene/acrylic acid ester for adjusting the water-resistance after drying
softening agents to provide flexibility for the coating and increase the flame resistance
aldehyde or melamine or urea resin in order to increase the water-resistance and cleaning stability as a preservative
acid for chemical hardening of the dried coatings.

The coating is carried out in an aqueous manner and the machines can advantageously be cleaned with water whilst still in the wet state so that a dropping time is substantially prevented.

### EXAMPLE 2

A diffuser layer is produced as a coating which can be processed in an aqueous manner with chemical hardening.

A corresponding emulsion contains:
water as a solvent
polyvinyl alcohol as a water-soluble emulsifier
an aqueous dispersion based on homo- or copolymer based on acetate or acrylate in order to produce the water-resistance in the dry film
anti-foaming agents for uniform coatings
wetting agents as an adhesion promoting agent for the fabric
preservatives to prevent decay
soap as a hardening accelerator
softening agents for flame retardation and elastification
isocyanate for aqueous media as a hardening agent in order to achieve the washing and cleaning stability.

Opacity is achieved in this instance by means of foaming as the coating is dried.

The coating is carried out in an aqueous manner. However, a dropping time is intended to be taken into account in which the material can still be processed. Dried residues on the machine can be mechanically removed.

### EXAMPLE 3

A diffuser layer is produced as a coating material which can be processed in an aqueous manner and which is made opaque by means of foam. The hardening is carried out subsequently using chemical additives.

A corresponding emulsion contains:
water as a solvent
polyvinyl alcohol as an aqueous emulsifier
homo- or co-polymer dispersion based on acetate/ethylene/acrylester in order to increase the water resistance
wetting agents to promote adhesion
preservatives to prevent decay
starch to increase the opacity
soap and air for foaming and adjusting the opacity
softening agents as a flame protection means
aldehyde or melamine or urea resin in order to increase the water-resistance
acid for subsequent hardening of the dried coating in order to achieve the cleaning stability.

The coating is intended to be processed as in example 1, but the opacity in this instance is achieved by means of a stabilised foam. An additional processing step is necessary—but provides an excellent degree of softness with good mechanical resistance.

If desired, an emulsion may also have, in accordance with any of the examples set out above, a light-amplifying, for example luminescent and/or phosphorescent additive.

In FIG. 4, using the example of an indicated monofilament thread 47, it is explained that the wide angularity of the scatter effect claimed by the invention is achieved only in the range of comparatively small thread diameters, whether they be monofilament or multifilament threads, which are less than 60 μm. The rear-projected image 41 which strikes an individual thread 47 is illustrated on the entire surface of the thread 47 only with the claimed small thread diameters—this is schematically illustrated as a distorted image 49′ on the rear side or as a distorted image 49″ on the front side of the opaque—transparent or partially transparent-thread 47. Only with a comparatively thin fabric—for example as explained as a fabric 20, 30 in FIG. 2, FIG. 3 by way of example—is it consequently possible for light beams 53, 55 which are scattered in a forward direction to be scattered not only on or in a narrow angular range about the vertical 51 relative to the rear projection surface 11—in this instance light beams 53 which are scattered forwards—but also in an angular direction which is almost at an angle of 90° relative to the vertical 51—in this instance light beams 55. That is to say, with a rear projection fabric according to the concept of the invention, the rear-projected image 41 can be scattered in a forward direction in a comparatively large angular range of practically from 0 to 180°. It is directly evident that a viewing angle range which is wide open in this manner from 0 to 180° can be achieved only with a thin fabric claimed in this instance, a thread density nonetheless being able to be in the claimed high range of more than seven threads per millimetre, without the light beams 55 which are scattered transversely relative to the vertical 51 being reflected back several times or scattered several times by threads adjacent to the thread 47. This is the case with comparatively thick and knitted surface structures, such as those in US 2006/0187544 A1. If attempts were made to provide such thick and knitted surface structures with a high thread density, there would be many occurrences of multiple scattering and backscattering and reflection with the result that ultimately there would remain only a pure forward scattering at the vertical 51 relative to the projection surface 11 or in a narrow angular range. It is absolutely necessary with such thick and knitted surface structures to provide a high degree of open space, disadvantageously compared with the concept of the invention, in order not to limit a viewing angle range to the vertical 51. However, in the manner described, this impairs the precision detail of a rear-projected image and further results in comparatively high losses of light.

Accordingly, a rear projection system 40 according to FIG. 4 can advantageously be provided with a rear projector 43 which lies well within the conventional data projector performance levels in terms of its light output. That is to say, owing to the rear projection fabric 20, 30 according to the concept of the invention, it is possible for the first time to provide a rear projection screen 10 for a rear projection system 40 which is also available at a reasonable price for the consumer sector, in particular outside the studio, for commercial purposes.

In conclusion, the invention—based on the finding that thin fabrics with a high thread density are highly suitable for producing precisely detailed rear projections with an extremely high degree of wide angularity—has set out, in a manner according to the invention, a rear projection fabric 20, 30 with a number of threads with a thread density of more than seven threads per millimetre and a maximum thread diameter of less than 0.06 mm. A diffuser layer reduces artefacts and increases the homogeneity of the rear-projected image. The invention relates to a rear-projection screen 10 which has such a rear projection fabric 20, 30 and which is capable of providing a particularly precisely detailed rear projection image 41 with a high degree of wide angularity. In particular, it is possible using such a rear projection screen to provide a comparatively inexpensive rear projection system 40 which can be constructed with conventional performance levels of a projector 43, for example, in the form of a data projector or laser.

1. Rear projection fabric for a rear projection screen, which is woven from a number of threads having a thread density of more than 7 threads per millimetre, the maximum diameter of a thread being less than 0.06 millimetres, and a thread being formed from one or more opaque fibres, or transparent fibres, or partially transparent fibres in particular textile fibres, and which has a diffuser layer.

2. Rear projection fabric according to claim 1, wherein a thread is produced in the form of a monofilament thread.

3. Rear projection fabric according to claim 1, wherein a thread is produced in the form of a multifilament thread comprising at least two fibres.

4. Rear projection fabric according to claim 1, wherein the thread density is greater than 12 threads per millimetre.

5. Rear projection fabric according to claim 1, wherein the thread density is less than 35 threads per millimetre.

6. Rear projection fabric according to claim 1, wherein the thread density is between 15 and 20 threads per millimetre.

7. Rear projection fabric according to claim 1, wherein the diameter of a thread is less than 0.05 millimetres.

8. Rear projection fabric according to claim 1, wherein the diameter of a thread is greater than 0.01 millimetres.

9. Rear projection fabric according to claim 1, wherein the diameter of a thread is in the range between 0.02 and 0.04 millimetres.

10. Rear projection fabric according to claim 1, wherein a ratio of thread density to thread diameter is in the range between 116 1/mm² and 3500 1/mm².

11. Rear projection fabric according to claim 1, wherein the fabric has a mesh size of less than 0.15.

12. Rear projection fabric according to claim 1, wherein the fabric has an open area of between 5% and 40%.

13. Rear projection fabric according to claim 1, wherein a thread is produced from one or more synthetic fibres.

14. Rear projection fabric according to claim 13, wherein the synthetic fibre has synthetic or natural polymer fibres or fibre mixtures therewith.

15. Rear projection fabric according to claim 1, wherein a fibre is produced with a polycondensation fibre.

16. Rear projection fabric according to claim 1, wherein a thread is produced with a polymerisation fibre.

17. Rear projection fabric according to claim 1, characterised in wherein a fibre is produced with a polyaddition fibre.

18. Rear projection fabric according to claim 1, wherein the fabric has an opaque coating.

19. Rear projection fabric according to claim 1, wherein the fabric has an impregnation and/or coating which is adapted to the fabric characteristics.

20. Rear projection fabric according to claim 1, wherein an impregnation and/or coating is applied as an emulsion.

21. Rear projection fabric according to claim 19, wherein the impregnation and/or coating further has: a wetting agent and/or a preservative.

22. Rear projection fabric according to claim 19, wherein the impregnation and/or coating has an elasticity agent.

23. Rear projection fabric according to claim 19, in wherein the impregnation and/or coating has an opacity agent.

24. Rear projection fabric according to claim 19, wherein the impregnation and/or coating has an additive which increases the water-resistance thereof.

25. Rear projection fabric according to claim 19, wherein the impregnation and/or coating is applied as an aqueous dispersion.

26. Rear projection fabric according to claim 19, wherein the impregnation and/or coating has an aldehyde or melamine or urea resin.

27. Rear projection fabric according to claim 19, wherein the impregnation and/or coating has hardening agents.

28. Rear projection screen having a rear projection surface which is formed by a rear projection fabric according to claim 1.

29. Rear projection screen according to claim 28, wherein the screen has a sleeve which surrounds the rear projection surface, and securing means.

30. Rear projection screen according to claim 29, wherein the securing means is configured for tensioned fixing of the rear projection surface.

31. Rear projection screen according to claim 29, wherein the securing means is formed with one or more tensioning rails.

32. Rear projection screen according to claim 28, wherein the rear projection surface is polygonal.

33. Rear projection system, having a rear projection screen according to claim 28, and further comprising a projector for projecting an image onto the rear side of the rear projection screen.

34. Rear projection system according to claim 33, wherein the projector is produced in the form of a data projector or laser.

35. Use of a rear projection fabric according to claim 1 for the rear projection of stationary or moving images.
